(19) United States
(12) Patent Application Publication
(10) Pub. No.: US 2008/0019740 A1
(43) Pub. Date: Jan. 24, 2008

(54) Image forming apparatus and image forming method

(75) Inventor: Tooru Oouchi, Tokyo (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies Inc., Tokyo (JP)

(21) Appl. No.: 11/819,900

(22) Filed: Jun. 29, 2007

(30) Foreign Application Priority Data
Jul. 24, 2006 (JP) 2006-200624

(51) Int. Cl. G03G 15/01

(52) U.S. Cl. 399/301

(57) ABSTRACT

Disclosed is an image forming apparatus includes a conveying section to convey recording media on which color images are to be formed; an image forming section to form first toner images by adhering color toners to an intermediate transfer belt and to transfer the first toner images onto the recording media, thereby forming the color images; a storing section to store image data of an image adjustment pattern image used in an image adjustment; and a control section which allows the image forming section to sequentially form second toner images for the image adjustment by dividing the image adjustment pattern image based on the image data, the second toner images are formed between the first toner images, the first toner images are to be transferred onto the recording media at a successive printing operation, and the control section controls the image adjustment utilizing the second toner images.

### CROSS-REFERENCE TO RELATED APPLICATIONS

The present U.S. patent application claims a priority under the Paris Convention of Japanese patent application No. 2006-200624 filed on Jul. 24, 2006, which shall be a basis of correction of an incorrect translation.

### BACKGROUND

1. Field of the Invention

The present invention relates to an image forming apparatus and an image forming method.

2. Description of the Related Art

In recent years, there is an image forming apparatus such as a printer in which an electrostatic latent image is formed on an intermediate transfer belt, toner adheres to the electrostatic latent image and the image is transferred to a recording medium, thereby forming the image on the recording medium. In this image forming apparatus, it is required to form an image on the recording medium more quickly and more beautifully.

In the image forming apparatus, in order to form a beautiful color image, it is necessary to perform image adjustment including adjustment of a printing position of each color and adjustment of an application amount of ink of each color. Generally, the image adjustment is performed when the power is activated, when a certain amount of sheets are printed (for example, per 100 page), when predetermined time is elapsed, when environment of the apparatus is changed, or when a consumable item such as a toner cartridge or a print unit is exchanged.

This image adjustment is performed with the above-described timing for suppressing variation in development, an exposure light amount, sensitivity of a photosensitive material, and variation of ink film thickness caused by variation in an electrification amount of toner due to environment or durability. The image adjustment is performed for correcting, to a constant level, variation in thin line reproducibility and variation in hollow reproducibility generated by variation (difference among individuals, environment and durability) of photosensitive electrostatic characteristics (electrification characteristics, exposure sensitivity characteristics), development characteristics (efficiency, edge enhancement), and transfer characteristics (fidelity, efficiency). The image adjustment is performed for obtaining gradation characteristics which are necessary for image processing when an image is formed, or for correcting a deviation from a color registration caused by variation and fluctuation of printing position of each color.

When the image adjustment is performed, if successive printing operation to a recording medium is being performed, for example, a current printing job is temporarily stopped to perform the image adjustment, and after the image adjustment is completed, the printing operation is restarted. Thus, when the image adjustment is performed during the successive printing operation, time required for forming an image on all of recording media becomes long, and the average printing speed is lowered. Especially when images are formed onto a large number of recording media, the image adjustment is performed two or more times in some cases, and time required for the image adjustment is not negligible.

As a method for shortening time required for the image adjustment, it is conceived to increase the number of image adjustment sensors as compared with the conventional technique and the image adjustment is performed. For example, Japanese Patent Application Laid-open No. 2005-31404 discloses a technique in which four image adjustment sensors are provided, image adjustments of four colors are performed at the same time, and the processing time required for the image adjustments is reduced to a value as short as one color processing time.

However, according to the above-described conventional technique, since it is necessary to provide many image adjustment sensors, there is a problem that cost is increased and cost-competitiveness is lost.

### SUMMARY OF THE INVENTION

The present invention has been accomplished in view of the problems of the conventional technique, and it is an object to provide a technique for performing an image adjustment during a successive printing operation of color images without increasing a producing cost of an apparatus and without lowering the printing speed.

An image forming apparatus reflecting one aspect of the present invention comprises: a conveying section to convey recording media on which color images are to be respectively formed; an image forming section to form first toner images by adhering color toners to an intermediate transfer belt and to respectively transfer the first toner images onto the conveyed recording media, thereby forming the color images; a storing section to store, therein, image data of an image adjustment pattern image which is used in an image adjustment of the color image formed by the image forming section; and a control section which allows the image forming section to sequentially form second toner images for the image adjustment which are formed by dividing the image adjustment pattern image based on the image data stored in the storing section, the second toner images being respectively formed between a plurality of the first toner images on the intermediate transfer belt, the first toner images being to be respectively and successively transferred onto a plurality of the recording media to respectively form a plurality of the color images onto the plurality of the recording media at a time of a successive printing operation by the image forming section, and the control section controlling the image adjustment by the image forming section utilizing the second toner images.

It is desirable that in the above described image forming apparatus, if all of the second toner images are not formed when the successive printing operation is completed, the control section allows the image forming section to form remaining of the second toner images to control the image adjustment by the image forming section.

It is desirable that in the above described image forming apparatus, the image data of the image adjustment pattern image stored in the storing section includes second image data of an adhesion amount adjustment pattern image for adjusting an amount of one of the color toners to be adhered to the recording medium, and the control section allows the image forming section to form, between the first toner images, third toner images for the toner adhesion amount adjustment to control the toner adhesion amount adjustment by the image forming section, the third toner images being formed by dividing the adhesion amount adjustment pattern image based on the second image data.

It is desirable that in the above described image forming apparatus, the image data of the image adjustment pattern image stored in the storing section includes second image data of a light amount adjustment pattern image for adjusting a light amount for forming one of the color toners to be transferred onto the recording medium, and the control section allows the image forming section to form, between the first toner images, third toner images for the light amount adjustment to control the light amount adjustment by the image forming section, the third toner images being formed by dividing the light amount adjustment pattern image based on the second image data.

It is desirable that in the above described image forming apparatus, the image data of the image adjustment pattern image stored in the storing section includes second image data of a γ value adjustment pattern image for adjusting a γ value of one of the color toners to be transferred onto the recording medium, and the control section allows the image forming section to form, between the first toner images, third toner images for the γ value adjustment to control the γ value adjustment by the image forming section, the third toner images being formed by dividing the γ value adjustment pattern image based upon the second image data.

It is desirable that in the above described image forming apparatus, the image data of the image adjustment pattern image stored in the storing section includes second image data of a registration pattern image for adjusting a deviation from a color registration of one of the color toners to be transferred onto the recording medium, and the control section allows the image forming section to form, between the first toner images, third toner images for adjusting a toner adhesion position of the one of the color toners to the intermediate transfer belt to control a degree of the deviation from the color registration.

It is desirable that in the above described image forming apparatus, the image data of the image adjustment pattern image stored in the storing section includes second image data of integrated adjustment pattern images for an integrated image adjustment of a toner adhesion amount of, a light amount for forming, a γ value of and a deviation from a color registration of one of the color toners to be transferred onto the recording medium, and the control section allows the image forming section to form, between the first toner images, third toner mages for the integrated image adjustment to control the integrated image adjustment by the image forming section, the third toner images being formed by respectively dividing the integrated adjustment pattern images based on the second image data.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a schematic block diagram showing a functional structure of an image forming apparatus 100 according to the present invention;

FIG. 2 is a schematic conceptional diagram showing structures of a conveying section 50, an image forming section 60 and a fixing section 70;

FIG. 3 is a schematic conceptional diagram showing contents of image forming command information X1;

FIG. 4A is a schematic conceptional diagram showing adhesion amount pattern formed on an intermediate transfer belt 64;

FIG. 4B is a schematic conceptional diagram showing a light amount pattern formed on the intermediate transfer belt 64;

FIG. 4C is a schematic conceptional diagram showing a γ characteristics pattern formed on the intermediate transfer belt 64;

FIG. 4D is a schematic conceptional diagram showing a registration pattern formed on the intermediate transfer belt 64;

FIG. 4E is a schematic conceptional diagram showing a integrated pattern formed on the intermediate transfer belt 64;

FIG. 5 is a flowchart showing operation of the image forming apparatus 100;

FIG. 6 is a flowchart showing operation of the image forming apparatus 100;

FIG. 7 is a conceptional diagram exemplifying regions between toner images at the time of a successive printing operation in the intermediate transfer belt 64;

FIG. 8 is a conceptional diagram exemplifying a forming state of an image adjustment pattern in between the toner images at the time of a successive printing operation in the intermediate transfer belt 64;

FIG. 9 is a conceptional diagram exemplifying the forming state of the image adjustment pattern in between the toner images at the time of a successive printing operation in the intermediate transfer belt 64;

FIG. 10 is a conceptional diagram exemplifying the forming state of the image adjustment pattern in between the toner images at the time of a successive printing operation in the intermediate transfer belt 64; and

FIG. 11 is a conceptional diagram exemplifying a forming state of the image adjustment pattern after the successive printing operation in the intermediate transfer belt 64 is completed.

### DESCRIPTION OF THE PREFERRED EMBODIMENTS

Embodiments of the present invention will be described in detail below with reference to the drawings, however the present invention is not limited to the embodiments described below. Also, the embodiments of the present invention is to show a best mode of the present invention and do not limit applications and terms of the present invention.

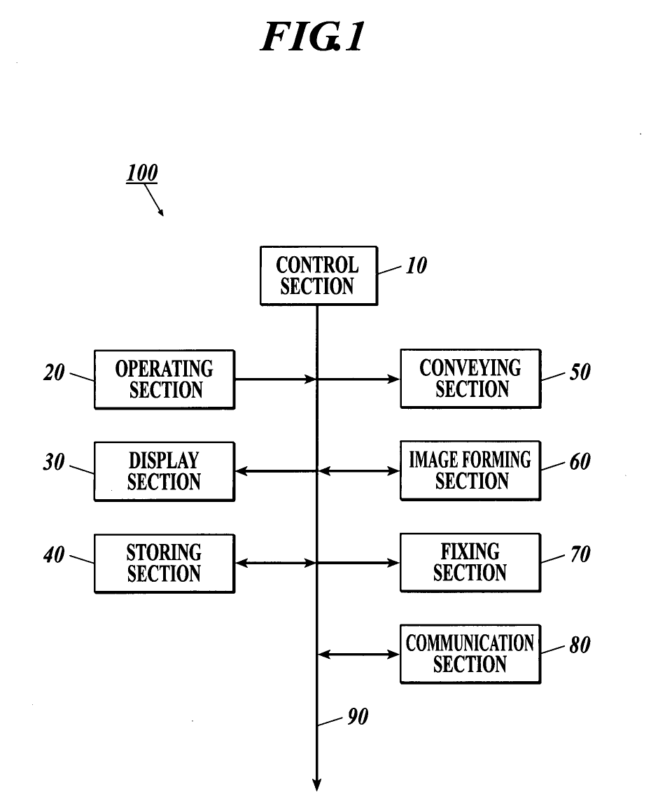

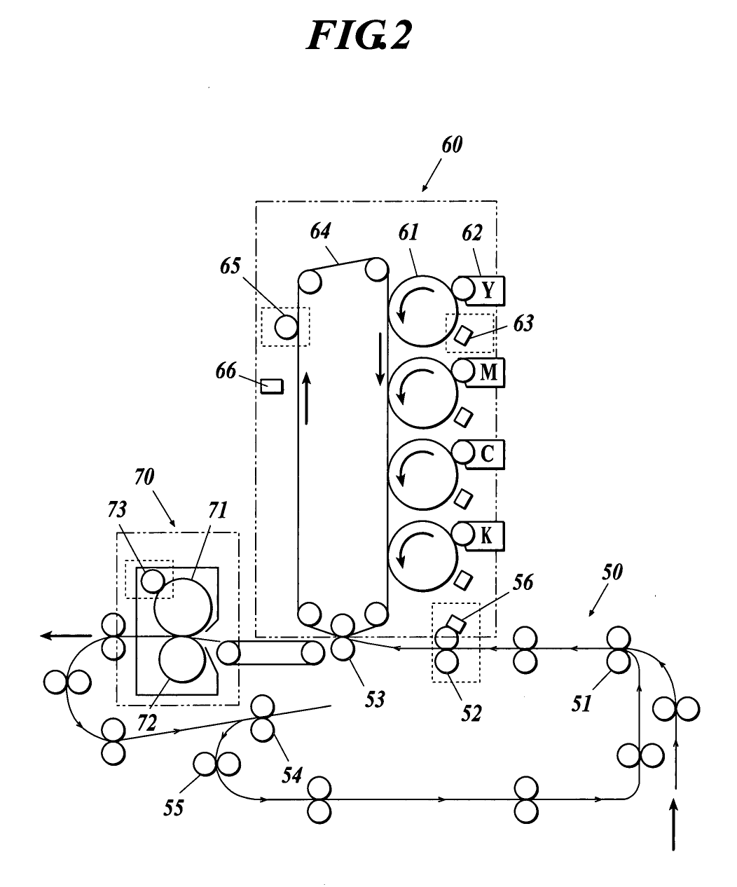

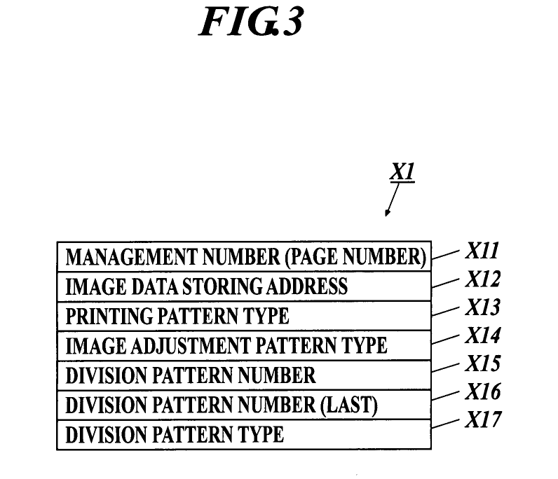

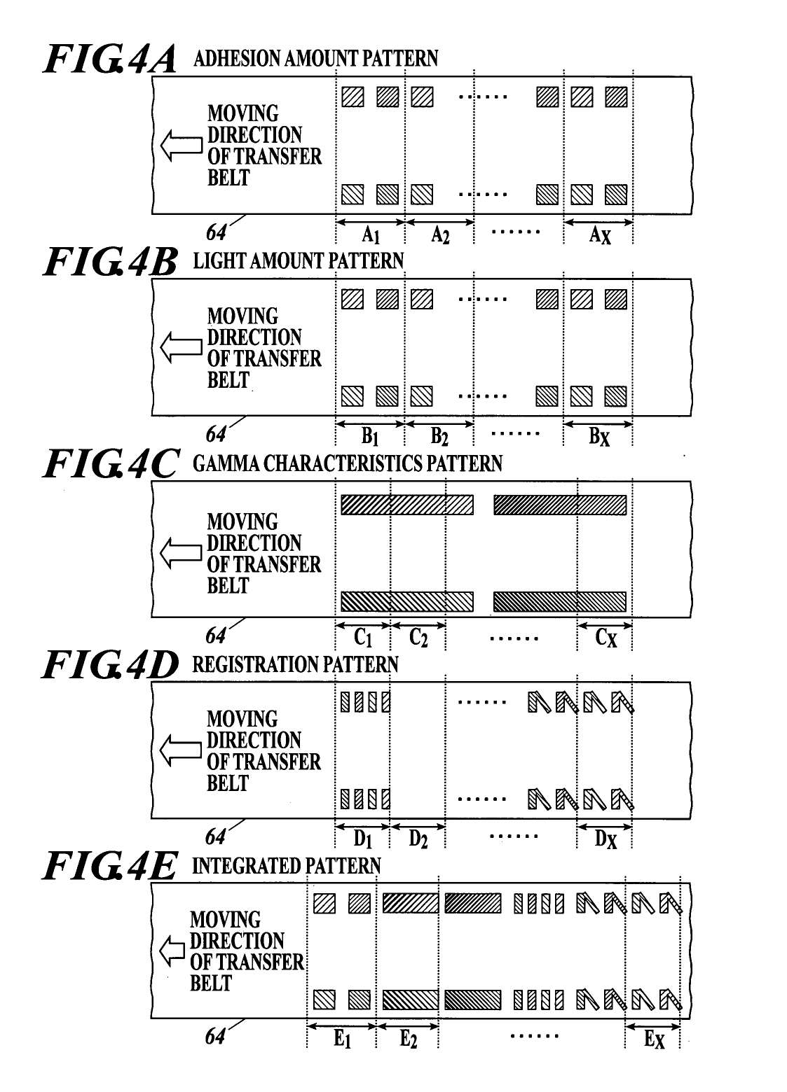

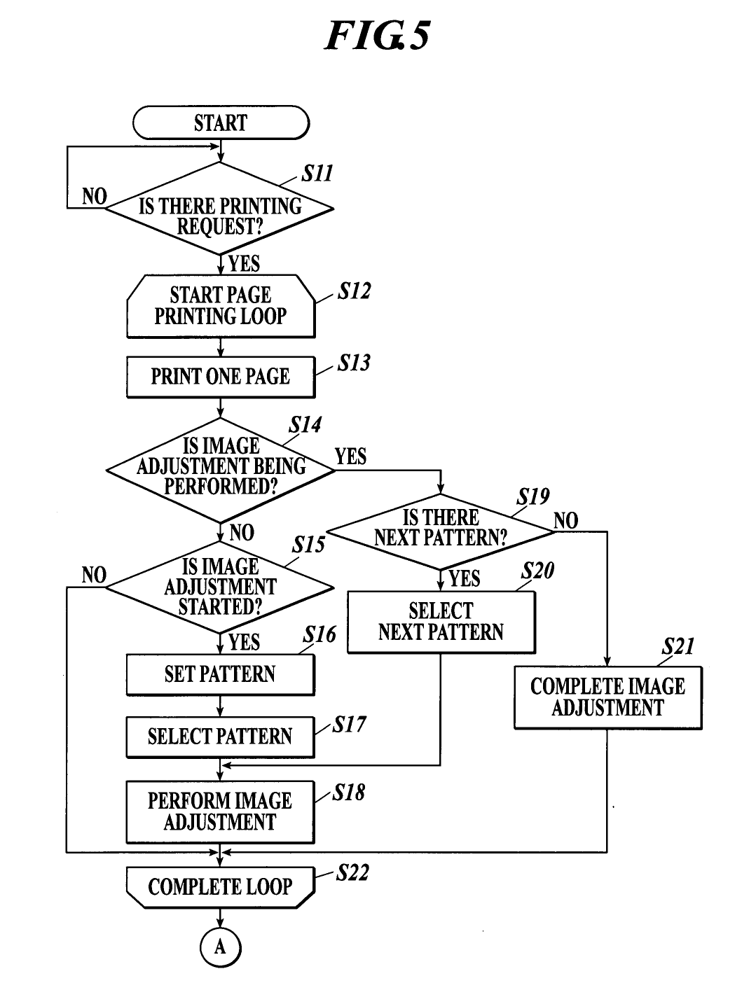

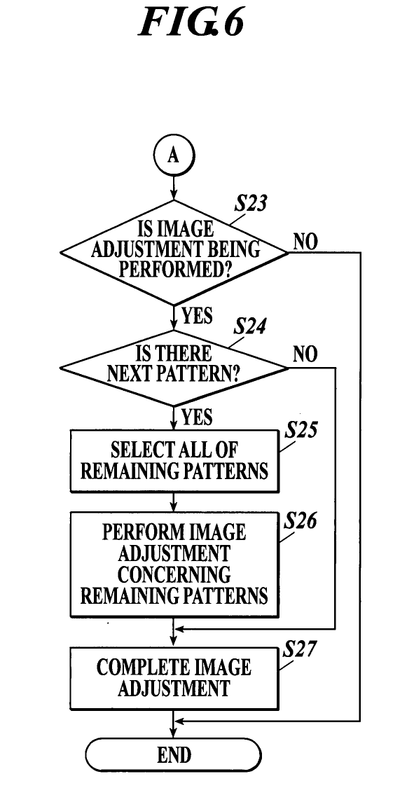

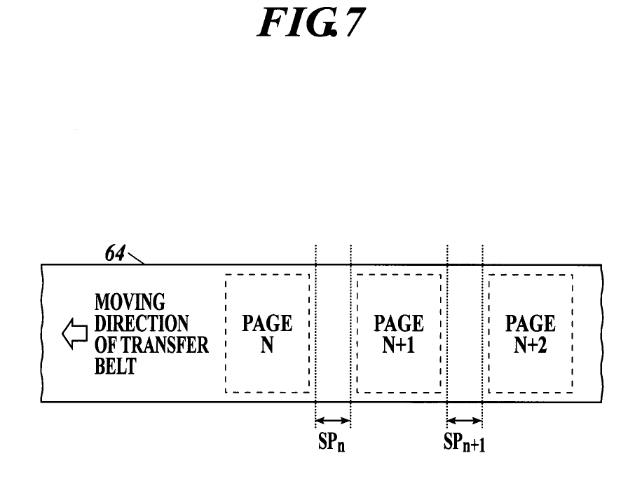

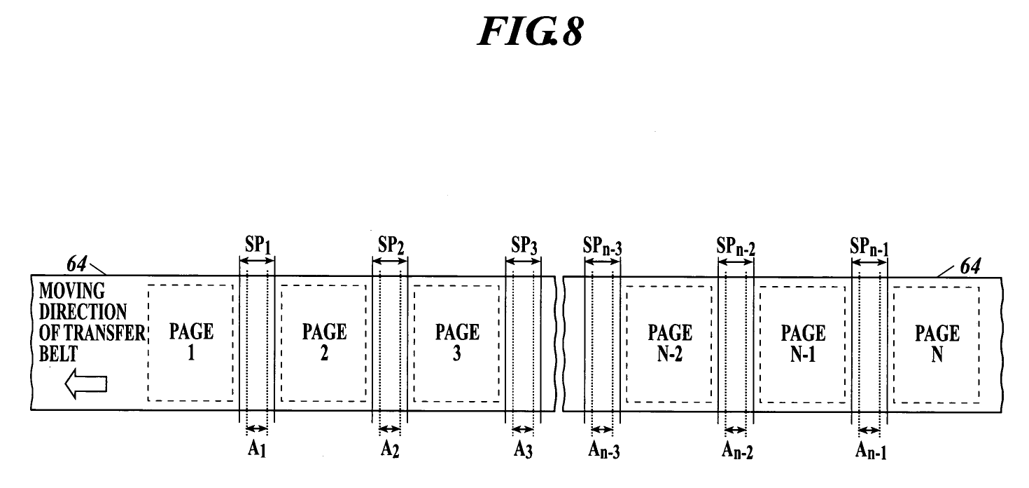

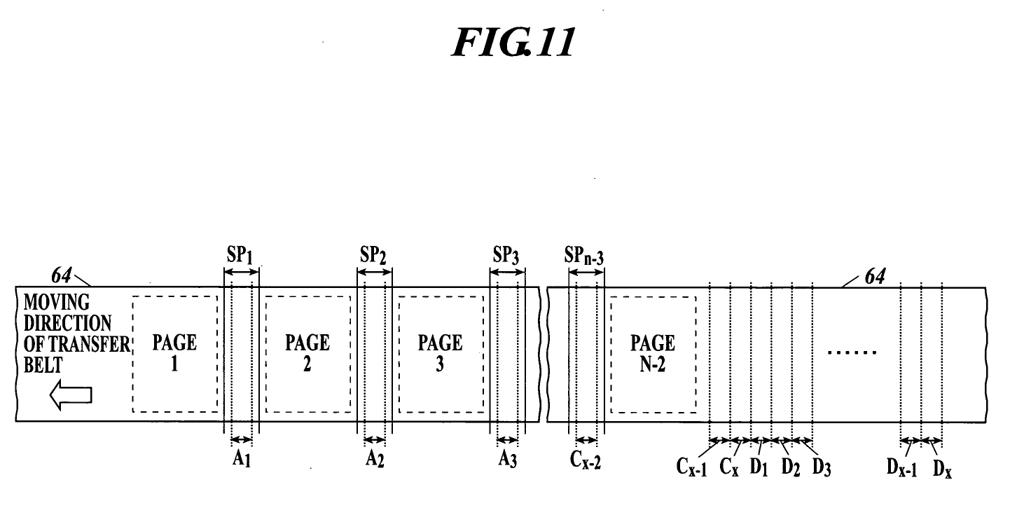

FIG. 1 is a schematic block diagram showing a functional structure of an image forming apparatus 100 according to the present invention. FIG. 2 is a schematic conceptional diagram showing structures of a conveying section 50, an image forming section 60 and a fixing section 70. FIG. 3 is a schematic conceptional diagram showing contents of image forming command information X1. FIG. 4A is a schematic conceptional diagram showing adhesion amount pattern formed on an intermediate transfer belt 64. FIG. 4B is a schematic conceptional diagram showing a light amount pattern formed on the intermediate transfer belt 64. FIG. 4C is a schematic conceptional diagram showing a γ characteristics pattern formed on the intermediate transfer belt 64. FIG. 4D is a schematic conceptional diagram showing a registration pattern formed on the intermediate transfer belt 64. FIG. 4E is a schematic conceptional diagram showing a integrated pattern formed on the intermediate transfer belt 64. FIGS. 5 and 6 are flowcharts showing operation of the image forming apparatus 100. FIG. 7 is a conceptional diagram exemplifying regions between toner images at the time of a successive printing operation in the intermediate transfer belt 64. FIGS. 8 to 10 are conceptional diagrams exemplifying a forming state of an image adjustment pattern in between the toner images at the time of a successive printing operation in the intermediate transfer belt 64. FIG. 11 is a conceptional diagram exemplifying a forming state o the image adjustment pattern after the successive printing operation in the intermediate transfer belt 64 is completed.

First, a structure of the image forming apparatus 100 which is a printer or a facsimile machine, etc. will be explained. As shown in FIG. 1, the image forming apparatus 100 includes a control section 10, an operating section 20, a display section 30, a storing section 40, a conveying section 50, an image forming section 60, a fixing section 70 and a communication section 80. These sections are connected with each other through a bus 90 so that communications can be carried out with each other. The image forming apparatus 100 has an image reading section, etc. for reading an original image (not shown). The image forming apparatus 100 may be a MFP (Multi Function Peripheral) which provides various functions other than those of a copier, a scanner and a printer.

The control section 10 includes a CPU (Central Processing Section), a ROM (Read Only Memory) and a RAM (Random Access Memory). The CPU develops in the work area of the RAM various control programs and various data stored in the ROM and the storing section 40 to have them sequentially executed, thereby the control section 10 controls operations of each section and controls the entire apparatus in a centralized manner.

More specifically, the control section 10 controls various sections based on a printing command from other information device which is input through the communication section 80 and a printing command which is input from the operating section 20, thereby forming an image in the image forming section 60. The control section 10 reads an image adjustment program and image adjustment data stored in the storing section 40 to sequentially have them executed, thereby controlling the adjustment of an image formed on a recording medium in the image forming section 60 by the later-described operation processing. The image adjustment executed by the control section 10 is started with timing based on a temperature variation of an atmosphere of the apparatus measured by a temperature sensor (not shown), elapsed time after the last adjustment measured by a timer, or the number of formation of an image in the image forming section 60.

The operating section 20 is for example, a pressure-sensitive (resistance film pressure type) touch panel in which transparent electrodes are arranged in a lattice fashion on a screen of an operation key panel (not shown) or the display section 30. The operating section 20 outputs an input operation signal to the control section 10. The operating section 20 is for example, an LCD (Liquid Crystal Display), and displays an image based on a display control from the control section 10.

The storing section 40 is a nonvolatile memory such as a magnetic, optical storing medium, semiconductor or the like, and is a section which can be read from and written to the control section 10. A program or data concerning the image adjustment in the image forming section 60, various control program of the entire apparatus, setting information of the apparatus, and data which is input from the communication section 80 are stored in the storing section 40.

The storing section 40 may have an interface to which a storing medium such as the magnetic, optical storing medium or the semiconductor memory can be detachably attached, and data may be read from and written to the storing section 40 through the interface. In this case, under the control of the control section 10, data which is previously stored in the attached storing medium can be read, various controls can be executed, an image can be formed in the image forming section 60, and data can be transferred to an external device from the communication section 80.

The conveying section 50 includes a later-described conveying mechanism and a paper feeding tray and a paper ejecting tray (both not shown). The conveying section 50 conveys a recording medium stored in the paper feeding tray to the image forming section 60, and outputs the recording medium with an image formed by the image forming section 60 to the paper ejecting tray under control of the control section 10.

The image forming section 60 transfers, based on colors, a toner image in which a toner is adhered to an electrostatic latent image formed on an photoconductive drum to an intermediate transfer belt in an overlapping manner, and forms a color image on the recording medium conveyed from the conveying section 50, and is a section which forms a color image on a recording medium in a so-called electrophotography manner. The fixing section 70 fixes the toner image formed on the recording medium by executing thermal fixing processing.

The communication section 80 has a communication interface which is connected to a communication circuit for carry out communication with other information device (not shown) or a network to which the other information device is connected. The communication section 80 carries out data communication under control of the control section 10.

Next, concrete structures of the conveying section 50, the image forming section 60 and the fixing section 70 will be explained. As shown in FIG. 2, the conveying section 50 includes various rollers such as loop rollers 51, registration rollers 52, transfer rollers 53, first reversing rollers 54 and second reversing rollers 55.

The conveying section 50 conveys the recording medium fed from the paper feeding tray to the image forming section 60 by means of the loop rollers 51, the registration rollers 52, the transfer rollers 53 and the like, an image is formed and fixed by the fixing section 70 and then, the recording medium is output to the paper ejecting tray or the like. The loop roller 51 conveys a recording medium conveyed from the paper feeding tray or the later-described second reversing roller 55 to the image forming section 60. The registration rollers 52 adjust the conveying timing at which a recording medium conveyed from the loop roller 51 is conveyed to the image forming section 60.

When a double-sided printing operation is performed, the conveying section 50 guides in a different direction from that of the paper ejecting tray downstream of the fixing section 70, front and back surfaces of the recording medium are reversed, and the recording medium is again supplied to the image forming section 60. A roller cleaning 56 for cleaning the roller abuts against the registration roller 52.

The image forming section 60 is provided above the transfer roller 53. The image forming section 60 is provided with an electrification electrode 62 and a developing section 63. In this embodiment, four units of the photoconductive drum 61 which are revolvable are provided in correspondence with toner of four colors, i.e., yellow (Y), magenta (M), cyan (C) and black (K). A cleaning section and a light writing section comprising an LED (Light Emitting Diode) array head or an LD (Laser Diode) unit (not shown) are provided around the photoconductive drum 61.

The electrification electrode 62 carries out corona discharge with respect to the surface of the photoconductive drum 61, and the surface of the photoconductive drum 61 is uniformly charged. The developing section 63 makes toner which is charged at the same pole as that of the photoconductive drum 61 adhere to the electrostatic latent image formed on the surface of the photoconductive drum 61 by the light writing section, thereby forming a toner image.

The toner images adhered to the surfaces of the photoconductive drums 61 are transferred to the intermediate transfer belt 64 disposed such as to be in contact with the four photoconductive drums 61. The intermediate transfer belt 64 is inserted between the transfer rollers 53 together with the recording medium, and a toner image on the intermediate transfer belt 64 is transferred to the recording medium by the pressing of the transfer rollers 53.

A cleaning belt 65 abuts against the intermediate transfer belt 64, and excessive toner remaining on the intermediate transfer belt 64 is removed.

A sensor 66 is for example, an optical sensor which measures a state of a toner image adhered to the intermediate transfer belt 64. The sensor 66 detects an amount of toner of each color adhered to the intermediate transfer belt 64 and the adhering position, and outputs the same to the control section 10. The control section 10 adjusts the amount of toner adhered to the intermediate transfer belt 64 and the position of the toner image based on a result of detection from the sensor 66.

With this, the image forming apparatus 100 can adjust, to a constant level, variation in thin line reproducibility and variation in hollow reproducibility generated by variation in photosensitive electrostatic characteristics (electrification characteristics, exposure sensitivity characteristics), development characteristics (efficiency, edge enhancement), and transfer characteristics (fidelity, efficiency).

The fixing section 70 is provided at the transfer roller 53 in the downstream of conveying direction. A heating roller 71 for heating a recording medium and a pressing roller 72 for pressing the recording medium are disposed in the fixing section 70 as fixing rollers. The recording medium on which a toner image adheres is conveyed to a nip portion between the heating roller 71 and the pressing roller 72 by the image forming section 60, toner which is melted by heat of the heating roller 71 is fixed to the recording medium, and the toner image is fixed to the recording medium by pressing of the heating roller 71 and the pressing roller 72. A cleaning roller 73 for cleaning a surface of the heating roller 71 abuts against the heating roller 71.

The image forming operation onto the recording medium in the conveying section 50, the image forming section 60 and the fixing section 70, and the image adjustment of the image forming section 60 are controlled based on a control command from the control section 10.

As show in FIG. 3, image forming command information X1 comprises a management number X11, an image data storing address X12, a print pattern type X13, an image adjustment pattern type X14, a division pattern number X15, a division pattern number X16 and a division pattern type X17.

The management number X11 is an identification number for managing a page number to be printed and the image adjustment. The image data storing address X12 is address information for accessing the RAM in the control section 10 and the storing section 40 to obtain image data concerning the management number X11. The print pattern type X13 instructs to form “normal print pattern” for normally printing on the recording medium, or “image adjustment pattern” for carrying out the image adjustment of the intermediate transfer belt 64.

The image adjustment pattern type X14 becomes effective when the print pattern type X13 instructs to form the “image adjustment pattern”, and the image adjustment pattern type X14 instructs a type of a toner image for the image adjustment to be formed on the intermediate transfer belt 64. More specifically, the image adjustment pattern type X14 instructs an “adhesion amount pattern”, a “light amount pattern”, a “γ characteristics pattern”, a “registration pattern”, an “integrated pattern” and presence or absence of the division of these patterns.

The division pattern number X15 becomes effective when it is instructed to form the “image adjustment pattern” and the pattern is to be divided, and a starting number of a divided pattern to be formed is instructed. The division pattern number X16 becomes effective when it is instructed to form the “image adjustment pattern” and the pattern is to be divided, and the last number, i.e., the ending number, of the divided pattern to be formed is instructed. In the instructions of the division pattern numbers X15 and X16, when the numbers thereof are the same, only a pattern having the corresponding number is formed, and when the numbers are different from each other, patterns having the numbers between the different two numbers are also formed collectively.

The division pattern type X17 becomes effective when it is instructed to form the “image adjustment pattern” and the pattern is to be divided, and the division pattern type X17 instructs that the patterns of corresponding the division pattern numbers X15 and X16 are whether a “top pattern” which is the top of the divided patterns, an “intermediate pattern” which is the intermediate pattern, or “last pattern” which is the last.

An image adjustment pattern formed on the intermediate transfer belt 64 based on the above-described control commands and the like will be explained. As shown in FIGS. 4A, 4B, 4C, 4D and 4E, there are the “adhesion amount pattern”, the “light amount pattern”, the “γ characteristics pattern”, the “registration pattern” and the “integrated pattern” as the image adjustment patterns. The image adjustment patterns shown in FIGS. 4A, 4B, 4C, 4D and 4E are formed by dividing a pattern into X-number of patterns, and these patterns are designated with 1 to X. Data for forming these patterns is previously stored for example, in the storing section 40, as image data whose address is designated and which can be read. The divided patterns are formed by adjusting an address at which the reading operation is started based on the number of divisions. Concerning the division of the image adjustment pattern, the number of division and the upper limit of the image width when dividing are previously set at the time of shipment so that the pattern stays within a gap between toner images of the intermediate transfer belt 64.

Image data concerning the image adjustment pattern stored in the storing section 40 may be one image data including information of all of the above-described various patterns. In this case, concerning the various patterns, pattern images obtained by dividing this pattern may be obtained by adjusting a reading address of the image data. The type of the image data is not limited to this, and each image adjustment pattern may be provided with one image data. In this type also, pattern images obtained by dividing each pattern can be obtained by adjusting the reading address of each image data. The image data stored in the storing section 40 may be one image data for each pattern image in which each image adjustment pattern is previously divided with a predetermined image width, and the divided pattern image may be obtained by sequentially reading the image data.

As shown in FIG. 4A, the adhesion amount pattern is formed in such a manner that the same shaped four pattern images of four colors, i.e., yellow (Y), magenta (M), cyan (C) and black (K) are varied in developing bias. In the control section 10, the sensor 66 reads this pattern, and the control section 10 determines appropriate developing bias.

As shown in FIG. 4B, the light amount pattern is formed in such a manner that the same shaped four pattern images of four colors, i.e., yellow (Y), magenta (M), cyan (C) and black (K) are varied in LED light amount. The control section 10 allows the sensor 66 to read this pattern, so as to determine appropriate LED light amount for forming a latent image.

As shown in FIG. 4C, in the γ characteristics pattern, the same shaped γ patterns in which gradation is varied are formed. The control section 10 allows the sensor 66 to read this pattern, and the control section 10 allows so as to correct, into an appropriate value, a gradation correction table which is referred to when an image is formed from the read value.

As shown in FIG. 4D, in the registration pattern, in order to correct color deviation of each color, various patterns having the same shape are formed by setting, into a particular value, operation frequency of the LED of the main scanning/auxiliary scanning/developing section 63. The control section 10 allows the sensor 66 to read this pattern so as to correct the pattern into appropriate main scanning/auxiliary scanning/video frequency.

As shown in FIG. 4E, the integrated pattern is formed with all of the above-described adhesion amount pattern, light amount pattern, γ characteristics pattern and registration pattern. The control section 10 allows the sensor 66 to read this pattern so as to perform general image adjustment. This integrated pattern is not a pattern for adjusting the entire region of correction of a value in the developing bias, light amount and gradation to be adjusted, and may be a pattern in which the above-described patterns are simplified for adjusting a value of a portion of a predetermined value (such as a threshold value).

Next, the operation of the image forming apparatus 100 which is performed by the control of the control section 10 will be explained in detail. As shown in FIG. 5, the control section 10 determines whether there is a printing command from the operating section 20 or the communication section 80 (step S11). When there is no printing command, the control section 10 is brought into a standby state while keeping the idling state. If the temperature is changed or predetermined time is elapsed in this idling state and the image adjustment is to be performed, the control section 10 performs the conventional image adjustment processing.

When there is a printing command in step S11, the control section 10 sets, to the management numbers X11 and X12, an address of data which is stored in the storing section 40 or the like for forming an image and a flag indicative of normal printing based on the printing command, and the control section 10 allows starting the page printing shown in steps S12 to S22. When there is a command of printing of a plurality of pages, this page printing is looped until the printing of all of pages is completed one page by one page.

At the time of the page printing operation, the control section 10 allows the image forming section 60 to print one page based on the printing command (step S13), and determines whether the image adjustment is being performed (step S14). When the image adjustment is not being performed, the control section 10 determines whether the image adjustment should be started based on the printed page number (step S15), and when the image adjustment is not started, the procedure is shifted to a loop for printing a next page.

When the image adjustment is to be started, the control section 10 sets one of or a plurality of the “adhesion amount pattern”, the “light amount pattern”, the “γ characteristics pattern”, the “registration pattern” and the “integrated pattern” (step S16). This setting may be performed in accordance with a portion to be adjusted. One of the patterns such as the “adhesion amount pattern” may be set, or some of them may be set or all of them may be set. The control section 10 selects one of division patterns to be formed between toner images of the intermediate transfer belt 64 among the set patterns at the time of the page printing operation (step S17), the control section 10 outputs, to the image forming section 60, a printing command for forming the division pattern between the toner images of the page printing, and performs the image adjustment based on a value detected by the sensor 66 (step S18).

If the image adjustment is being performed in step S14, i.e., if the image adjustment is started in step S15 in the last loop processing, the control section 10 determines whether there is a “Next pattern” which is a division pattern whose output of the image adjustment is not selected among the patterns set in step S16 (step S19). If there is the “Next pattern”, one division pattern in the “Next pattern” is selected (step S20), and the image adjustment is performed like in step S18. When there is no “Next pattern”, i.e., when the image adjustment is performed in all of the division patterns of the patterns set in step S16, the control section 10 completes the image adjustment (step S21).

As shown in FIG. 6, after the page printing operation in steps S12 to S22 is completed, i.e., after the printing operation of all pages is completed, the control section 10 determines whether the image adjustment is being performed like in step S14 (step S23). When the image adjustment is not being performed, the procedure is completed as it is. When the image adjustment is being performed, the control section 10 determines whether there is a “Next pattern” like in step S19 (step S24). If there is the “Next pattern”, all of the remaining division patterns whose outputs are not selected for the image adjustment are selected (step S25), a printing command for forming the remaining division patterns is output to the image forming section 60, an image adjustment based on a value detected by the sensor 66 is performed (step S26), and the image adjustment is completed (step S27). If there is no “Next pattern” in step S24, the control section 10 completes the image adjustment as it is (step S27).

The image forming apparatus 100 carries out the successive page printing operation under the control of the control section 10. Since the conveying operation of the recording medium to the image forming section 60 is adjusted by the registration rollers 52 at the time of the successive page printing operation, regions SPn and SPn+1 are generated between toner images in the page printing on the intermediate transfer belt 64 as shown in FIG. 7.

As shown in FIG. 8, in the image forming apparatus 100, if the page printing operation in the above-described steps S12 to S22 is performed, it is possible to perform the image adjustment for forming division adhesion amount patterns A1 to An−1 for adjusting the adhesion amount which are formed in the regions SP1 to SPn−1 between the toner images according to pages 1 to N. In addition to the embodiment exemplified in FIG. 8, the image adjustment may be performed by forming any of the “light amount pattern”, the “γ characteristics pattern”, the “registration pattern” and the “integrated pattern”.

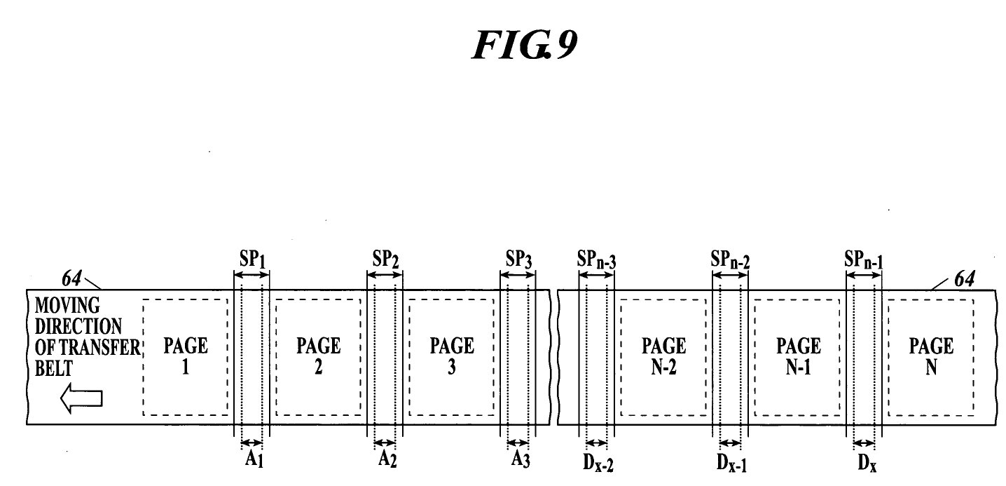

Similarly, in the image forming apparatus 100, as shown in FIG. 9, it is possible to perform the image adjustment by a plurality of patterns in which a division adhesion amount pattern A1 to a division registration pattern Dx for correcting the adhesion amount and the color deviation are formed in the regions SP1 to SPn−1 between the toner images according to the pages 1 to N. In addition to the embodiment exemplified in FIG. 9, one or some of the patterns may be combined, or all of the patterns may be formed to perform the image adjustment.

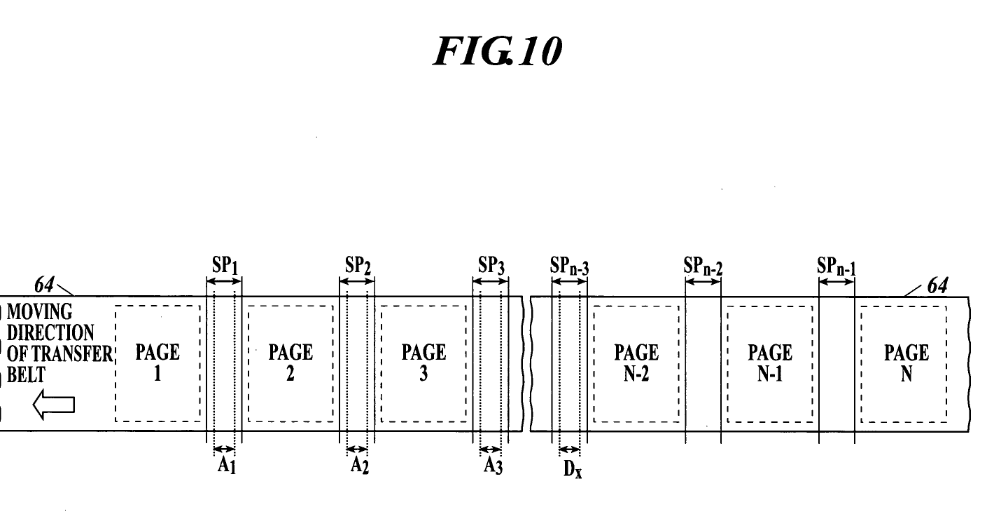

In the image forming apparatus 100, as shown in FIG. 10, it is possible to perform image adjustment in which patterns (a division adhesion amount pattern A1 to a division registration pattern Dx) divided only in regions SP1 to SPn−3 between toner images during the performing of the image adjustment are formed.

In the image forming apparatus 100, as shown in FIG. 11, if steps S23 to S27 are performed after the page printing operation is completed, image adjustment in which patterns divided by the regions SP1 to SPn−3 between toner images can be performed, and even after the printing operation is completed at page N−2 during which the image adjustment is being executed, it is possible to perform image adjustment in which the remaining division patterns (a division γ characteristics pattern Cx−1 to a division registration pattern Dx) are formed.

When image adjustment is performed during the successive printing operation by the image forming section 60 under the control of the control section 10, the image forming apparatus 100 sequentially forms image adjustment patterns between a plurality of toner images on the intermediate transfer belt 64, and the sensor 66 detects the pattern and adjusts the image. Therefore, the image forming apparatus 100 can perform the image adjustment of a color image to be formed without newly providing a sensor for efficiently performing the image adjustment, without stopping the successive printing operation, or without lowering the printing speed.

That is, the image forming apparatus 100 can perform an image adjustment during successive printing of color images without increasing a producing cost of the apparatus and without lowing a printing speed.

When the successive printing operation is completed, the image forming apparatus 100 forms remaining image adjustment patterns other than patterns which were sequentially formed between the plurality of toner images, and performs the image adjustment. Therefore, the image forming apparatus 100 can reliably perform all of the image adjustments even when image adjustment during the successive printing operation is completed at the halfway stage.

The image forming apparatus 100 sequentially forms a pattern which divides one of or a plurality of the “adhesion amount pattern”, the “light amount pattern”, the “γ characteristics pattern”, the “registration pattern” and the “integrated pattern” between a plurality of toner images during the successive printing operation by the image forming section 60, and the image forming apparatus 100 performs the image adjustment. Therefore, the image forming apparatus 100 can swiftly perform the general image adjustment such as the toner adhesion amount, the image light amount, the γ characteristics and color deviation during the successive printing operation.

The description in the embodiment shows one example of the present invention, and the invention is not limited to the description. The structure and the operation in the embodiment can appropriately be changed within a range not departing from the subject matter of the invention.

What is claimed is:

1. An image forming apparatus, comprising:
a conveying section to convey recording media on which color images are to be respectively formed;
an image forming section to form first toner images by adhering color toners to an intermediate transfer belt and to respectively transfer the first toner images onto the conveyed recording media, thereby forming the color images;
a storing section to store, therein, image data of an image adjustment pattern image which is used in an image adjustment of the color image formed by the image forming section; and
a control section which allows the image forming section to sequentially form second toner images for the image adjustment which are formed by dividing the image adjustment pattern image based on the image data stored in the storing section, the second toner images being respectively formed between a plurality of the first toner images on the intermediate transfer belt, the first toner images being to be respectively and successively transferred onto a plurality of the recording media to respectively form a plurality of the color images onto the plurality of the recording media at a time of a successive printing operation by the image forming section, and the control section controlling the image adjustment by the image forming section utilizing the second toner images.

2. The image forming apparatus of claim 1, wherein, if all of the second toner images are not formed when the successive printing operation is completed, the control section allows the image forming section to form remaining of the second toner images to control the image adjustment by the image forming section.

3. The image forming apparatus of claim 1, wherein, the image data of the image adjustment pattern image stored in the storing section includes second image data of an adhesion amount adjustment pattern image for adjusting an amount of one of the color toners to be adhered to the recording medium, and
the control section allows the image forming section to form, between the first toner images, third toner images for the toner adhesion amount adjustment to control the toner adhesion amount adjustment by the image forming section, the third toner images being formed by dividing the adhesion amount adjustment pattern image based on the second image data.

4. The image forming apparatus of claim 1, wherein, the image data of the image adjustment pattern image stored in the storing section includes second image data of a light amount adjustment pattern image for adjusting a light amount for forming one of the color toners to be transferred onto the recording medium, and
the control section allows the image forming section to form, between the first toner images, third toner images for the light amount adjustment to control the light amount adjustment by the image forming section, the third toner images being formed by dividing the light amount adjustment pattern image based on the second image data.

5. The image forming apparatus of 1, wherein, the image data of the image adjustment pattern image stored in the storing section includes second image data of a γ value adjustment pattern image for adjusting a γ value of one of the color toners to be transferred onto the recording medium, and
the control section allows the image forming section to form, between the first toner images, third toner images for the γ value adjustment to control the γ value adjustment by the image forming section, the third toner images being formed by dividing the γ value adjustment pattern image based upon the second image data.

6. The image forming apparatus of claim 1, wherein, the image data of the image adjustment pattern image stored in the storing section includes second image data of a registration pattern image for adjusting a deviation from a color registration of one of the color toners to be transferred onto the recording medium, and
the control section allows the image forming section to form, between the first toner images, third toner images for adjusting a toner adhesion position of the one of the color toners to the intermediate transfer belt to control a degree of the deviation from the color registration.

7. The image forming apparatus of claim 1, wherein, the image data of the image adjustment pattern image stored in the storing section includes second image data of integrated adjustment pattern images for an integrated image adjustment of a toner adhesion amount of, a light amount for forming, a γ value of and a deviation from a color registration of one of the color toners to be transferred onto the recording medium, and
the control section allows the image forming section to form, between the first toner images, third toner mages for the integrated image adjustment to control the integrated image adjustment by the image forming section, the third toner images being formed by respectively dividing the integrated adjustment pattern images based on the second image data.

8. An image forming method, comprising:
performing a successive printing operation by forming first toner images in which color toners are adhered to an intermediate transfer belt and by respectively and successively transferring the first toner images onto a plurality of the recording media to respectively form a plurality of color images onto the plurality of recording media; and
performing an image adjustment by sequentially forming second toner images which are formed by dividing an image adjustment pattern image for the image adjustment of the color image based on image data of the image adjustment pattern image stored in a storing section, the second toner images being respectively formed between the plurality of the first toner images on the intermediate transfer belt.

9. An image forming method of claim 8, further comprising forming remaining of the second toner images if all of the second toner images have not been formed when the successive printing operation is completed, thereby performing the image adjustment.
